(19) United States
(12) Patent Application Publication
(10) Pub. No.: US 2024/0377500 A1
(43) Pub. Date: Nov. 14, 2024

(54) POSITION FINDING BY DETERMINATION OF DISTANCES IN THE SPECTRUM

(71) Applicant: Lambda:4 Entwicklungen GmbH, Hamburg (DE)

(72) Inventor: Rönne REIMANN, Hamburg (DE)

(73) Assignee: Lambda:4 Entwicklungen GmbH, Hamburg (DE)

(21) Appl. No.: 18/640,074

(22) Filed: Apr. 19, 2024

(30) Foreign Application Priority Data
May 12, 2023 (EP) 23172984.9

(51) Int. Cl. G01S 5/02; H04W 64/00

(52) U.S. Cl. CPC G01S 5/0273; H04W 64/00

(57) ABSTRACT

The invention relates to the determination of the position of an object arranged in a space. The method according to the invention is characterized by the radio signal transmitted containing at least one frequency pair with a respective frequency difference, and changes in phase changes between the at least two frequencies of a frequency pair being determined and signal components of at least two signal paths with different signal path lengths of the received radio signal being determined from the changes. According to the invention, at least one possible starting position, wherein the at least one possible starting position is determined in such a way that a radio signal hypothetically transmitted from the at least one possible starting position can propagate to the second object via signal paths whose signal path lengths correlate with those of the at least two determined signal paths.

### TECHNICAL FIELD

The invention relates to the determination of the position of an object arranged in a space by evaluating the radio signal transmitted and/or received by the object.

### BACKGROUND ART

The determination of the position of an object by determining several distances of the object to several reference points is known from the prior art.

Particularly with objects that transmit radio signals, determination of the runtime of the signal to different receivers in order to determine the position of the object in relation to the receivers is known from the prior art. To do this, the possible positions of each receiver are determined as a set of possible positions and the intersection of the sets of positions of the receivers is assumed to be the position of the object.

One disadvantage of the aforementioned solutions is that the position of the receivers, at least relative to each other, must be known in order to determine the position of the transmitter. Multipathing normally also has a negative effect on the known methods, so that attempts are often made to avoid multipathing or to mathematically avoid errors caused by multipathing in the position determination. Such methods are known, for example, from WO2015102713A2, U.S. Pat. No. 10,459,065B2, WO2012066541A2, WO2009047546A1, EP2778710A2 and US2016277893A1.

The determination of three multipath runtimes using UWB signals is also known from CN113532437A: conversion of these three runtimes into three distances, drawing circles with the radii of the distances and assuming the point of intersection of the circles as the position. This method has numerous disadvantages: UWB requires high power, involves a great deal of interference, determination of the runtimes is challenging and the points of intersection of the three circles can only be used to determine one position, let alone the correct one, in very few situations, in particular in environments with numerous reflective surfaces. This is generally not possible.

Furthermore, a solution is known from US2015247916A1 from another field of technology where the runtimes of ultrasound are determined using different signal paths in order to determine the position of a reflector.

### SUMMARY OF THE INVENTION

The object to be achieved by the invention is thus to make the determination of the position of an object transmitting and/or receiving a radio signal simpler, faster and more reliable, in particular in environments with strong multipathing. A single position does not necessarily have to be determined; it may also be sufficient if several possible positions are determined.

The object is achieved by a method as described below, in particular a method according to a method for determining the position of a first object arranged in a space wherein the first object transmits at least one radio signal and wherein at least one second object arranged in the space, namely a receiver, is set up to receive the at least one radio signal transmitted by the first object, said containing at least one frequency and at any time having a maximum bandwidth of 50 MHz, with the position of at least one reflective surface reflecting the radio signal and thus generating a further extended signal path and the position of the receiver being known in relation to the space, with signal components being determined from the received radio signal, characterized in that the radio signal contains at least one frequency pair with a respective frequency difference between the frequencies of the pair, and changes in phase changes between the at least two frequencies of a frequency pair being determined from the received radio signal using phase measurements on the at least one radio signal, and signal components of at least two signal paths with different signal path lengths of the received radio signal being determined from the changes, and at least one possible starting position of the radio signal being determined as one or more possible position(s) of the first object, wherein the at least one possible starting position is determined in such a way that a hypothetical radio signal transmitted from the at least one possible starting position can propagate to the second object via signal paths whose signal path lengths correlate with those of the at least two determined signal paths. Further solutions, in particular advantageous embodiments of the aforementioned solutions, are presented in the appended claims and in the following description.

The method according to the invention comprises a method for determining a position of at least one first object.

According to the invention, the at least one first object is set up and, in particular, configured to transmit at least one radio signal. Alternatively, or additionally, the at least one first object can be set up and in particular configured to receive at least one radio signal, in particular be a receiver or a transceiver.

In particular, the at least one radio signal can comprise at least one frequency, in particular at least two, advantageously 4 or more frequencies.

The at least one radio signal advantageously has a maximum bandwidth of 50 MHz, in particular a maximum bandwidth of 25 MHz, at any time. In particular, the radio signal may be a narrow-band and/or non-ultra-wideband (UWB) radio signal

In the method according to the invention, at least one second object is set up, in particular configured, to receive at least one radio signal transmitted by the first object. In particular, the at least one second object is a receiver or transceiver. Alternatively, in particular when the at least one first object is set up and in particular configured to receive at least one radio signal, the at least one second object is (also) set up, in particular configured to transmit at least one radio signal.

In particular, the at least one radio signal can comprise at least one frequency, in particular at least two, advantageously four or more frequencies.

The at least one radio signal advantageously has a maximum bandwidth of 50 MHz, in particular a maximum bandwidth of 25 MHz, at any time. In particular, the radio signal may be a narrow-band and/or non-ultra-wideband (UWB) radio signal.

Advantageously, both the at least one first object and the at least one second object can be set up and, in particular, configured to transmit at least one radio signal and to receive at least one radio signal. In particular, the at least one first object and the at least one second object can each be a transceiver. The above applies in particular with regard to the radio signal. The method can therefore be carried out either in one of the two directions or simultaneously or successively in both directions between the first and second objects. A plurality of first and/or second objects can also be used. The position of the active or passive object can thus be determined. The objects can also assume both the passive and the active role one after another or simultaneously.

The radio signal received at one of the objects, which originates from the other of the objects that originally transmitted the radio signal, is hereinafter referred to as the received signal.

For example, the other of the objects may be one of the at least one first objects and the receiving object may be one of the at least one second objects. However, the reverse constellation is also possible. It is conceivable in particular that the radio signal received at one of the objects does not completely match the radio signal transmitted by the other object. Such a phenomenon is known, for example from multipathing effects.

For example, a first signal transmitted by the first object and a further signal transmitted later, but otherwise identical, may arrive at and be received by the receiver in an overlapping manner, depending on the path traveled by the respective signal. For example, the further signal may have been (partially) transmitted directly from the first object to the receiver (line of sight (LOS) signal), whereas the first signal may have been (partially) reflected, thus prolonging the runtime and therefore the length of the path of the signal component.

Advantageously, the at least one first object and/or the at least one second object may in particular be located in a reference system, in particular arranged therein. In particular, it/they may be arranged within the reference system. However, it is also possible that the at least one first object or at least one of the at least one first objects involved in the method is not arranged in the reference system. It is also possible that the at least one second object, in particular the at least one receiver, or at least one of the second objects involved in the method, is not arranged in the reference system. Advantageously, the at least one radio signal runs from the object emitting the radio signal, for example the first object, to the object receiving the radio signal emitted by the object, for example the second object, at least temporarily and/or in sections through the reference system. Advantageously, the aforementioned and subsequently mentioned reference system can be a room, in particular an indoor room.

According to the invention, the position of at least one, in particular at least two, reflective surface(s) is/are known in the method. The reflective surface(s) is/are in particular set up and in particular configured to reflect at least the radio signal. In particular the reflection of the radio signal at the reflective surface extends the signal path from the transmitter to the receiver of this radio signal part compared with the direct signal path from the transmitter to the receiver.

Advantageously, the position of the at least one reflective surface in relation to a reference system, in particular the above-mentioned reference system, can be known.

According to the invention, either the position of the at least one first object or the position of the at least one second object is known in the method, while in particular the position of the other object is to be determined.

Advantageously, either the position of the at least one first object or the position of the at least one second object can be known with respect to a reference system, in particular to the above-mentioned reference system. Advantageously, the reference system is a space, in particular a confined space, more particularly an interior space, for example a room.

According to the invention, at least the position of at least one reflective surface and, in addition, either the position of the at least one first object or the position of the at least one second object, at least relative to one another, are thus known.

Preferably, with respect to the knowledge of the position in the context of the entire disclosure of the invention, at least the relative position of the at least one reflective surface can be understood either with respect to the at least one first object or with respect to the at least one second object. For example, the relative position of a first reflective surface with respect to a second object is known. Furthermore, for example, a relative position of a second reflective surface to the first reflective surface can be known, and thus also the relative position of this second reflective surface to the first or second object. If only the relative position is known, it goes without saying that only the relative position of the first or second object to the reference point of the relative position system can be determined, nevertheless in accordance with the invention. However, with regard to the knowledge of the position in the context of the entire disclosure of the invention, the absolute position of at least one first element of the elements comprising, on the one hand, the reflective surface and, on the other hand, the first or second object and the relative position of the further elements comprising, on the one hand, the reflective surface and, on the other hand, the first or second object, to the first element can also be understood

In the method according to the invention, signal components are determined from the received signal. In particular, the signal components are assigned to at least one signal path. Such a determination of signal components is basically known, for example in order to take only certain signal components into consideration in the further analysis. The determination of possible signal path lengths at different frequencies and the determination of a distance based on this, for example to exclude 2-pi-related ambiguities caused by the use of different frequencies, is also known from the prior art.

The method according to the invention is now characterized in that the signal components of at least two signal paths with different signal path lengths from the transmitter to the receiver are determined. Said at least two different signal components and/or signal path lengths of a radio signal received by a receiver from a transmitter are in particular those of a radio signal transmitted by a transmitter. This does not rule out in particular that this is carried out on a plurality of frequencies and/or frequency differences and/or frequency pairs in each case and/or that signal components for different signal paths are determined for the different frequencies, frequency pairs and/or frequency differences. Nevertheless, the method according to the invention differs from known methods, i.e. in that the signal components of at least two signal paths from the transmitter to the receiver are determined at least for one (single) frequency and/or one single frequency pair and/or one single frequency difference.

The determination is carried out using at least one phase measurement on the at least one radio signal. Numerous methods are known for this. For example, a complex measured value can be formed from the received amplitude or energy and phase. This can be used to form vectors or matrices, in particular when using several antenna paths and/or frequencies and/or frequency differences, which can be autocorrelated with one another. The resulting complex matrices can then be used to determine signal components. The change in phase between two measurements at different frequencies can also be used for the phase measurement. This avoids problems related to phase jumps during reflection and is less demanding on the measurement hardware and/or time synchronization. An average value can then be used, for example, as the amplitude or energy. A Fourier transformation or FFT can also be used, for example, to determine the signal components and/or signal path lengths.

According to the invention, at least one possible starting position of the radio signal is determined as one or more possible positions of the first object, wherein the at least one possible starting position is determined in such a way that a radio signal hypothetically transmitted from the at least one possible starting position can propagate to the second object via signal paths whose signal path lengths correlate with those of the at least two determined signal paths. The hypothetical radio signal is to be understood in particular as a signal whose propagation is mathematically analyzed but is not actually transmitted. In this way, the approximate propagation of a signal can be calculated mathematically. Correlation means in particular that a deviation, in particular a predetermined deviation, is not exceeded and/or that there is a match.

For example, different candidates for the possible starting positions can be tested or an analysis can be carried out with regard to possible signal paths. The more precisely the environment, in particular the reflective surfaces and/or the space, is known, the better/more accurately this can be done.

The at least one possible starting position can then be assumed to be the possible position of the first object.

The at least one possible starting position can be, for example, a single point, a set of individual points, a cloud of points and/or several clouds of points. Points or clouds can also be assigned probabilities or probability distributions. This is particularly advantageous if the results are to be compared and/or correlated with results obtained from other methods.

In the method according to the invention, a signal path length can be determined for each of the determined signal components, with the signal path length corresponding in particular to the length of the path of the signal between the second object and the first object. Thus, at least one signal path length, preferably more, in particular at least two, is determined for each receiver and/or each transmitter, at least with respect to at least one receiver.

For example, for a plurality of candidates for possible starting positions, for example the points of a grid, it is possible to determine whether signal path lengths of signal paths of the propagation of an emitted hypothetical radio signal from the respective candidate to the second object correlate with the signal paths of the at least two determined signal paths. In particular, if the correlation exceeds a correlation, in particular a predetermined correlation, the respective candidate is assumed to be a possible position of the first object.

The signal path lengths of one or all the signal paths can be determined. The selection can be made on the basis of various criteria and/or constraints, such as the number and/or angle of the reflections. However, knowledge of the surroundings can also provide further useful constraints. For example, points behind a structure that is largely impermeable to the at least one radio signal without corresponding reflective surfaces to establish an indirect signal path can be excluded. It is also conceivable to determine the direction of incidence of the at least one radio signal at the receiver and thereby exclude certain signal paths.

It is a particular advantage if the possible starting positions and/or candidates are points on a grid, i.e. in particular the points that are considered as starting positions. This makes it easier to perform the method arithmetically.

Particularly preferable candidates for the at least one possible starting position are those points that lie in a circle around the receiver, a sphere around the receiver and/or in a circular ring and/or a spherical ring around the receiver, in particular with an outer radius or a radius lying in the ring with the shortest of the at least two signal path lengths. The first object cannot be further away from the receiver than the shortest signal path length that can be derived from the at least one radio signal. This means that the receiver cannot be located further away, where necessary after adding an uncertainty due to measurement inaccuracies. The search can therefore be limited to a circle (for a two-dimensional view) or sphere. If it is also assumed that a direct or LOS signal path (i.e. without reflection) is always detected, or at least one that is not larger than the direct signal path by more than a predetermined factor, the search can be restricted to a circular or spherical ring or even to a circumference of a circle or spherical surface.

At least one possible starting position of the radio signal can be determined for each of the at least two determined signal path lengths. The at least one possible starting position of the radio signal can preferably, in particular as a first possible starting position, take into account a reflection and, in particular as a second possible starting position, no reflection of the received signal. In this way, a first possible starting position can be determined assuming no reflection/an LOS signal path and a second possible starting position assuming a reflection of the signal. Further, the possible starting position may also include an area or multiple possible starting positions that take into account mathematical uncertainties and/or different angles of reflective surfaces and/or different points of reflection and/or different reflective surfaces.

In particular, the possible starting positions of a signal path length each form a set of possible positions. A set of possible positions, which for example represents a plurality of lines and/or one or more areas, can therefore in particular represent a plurality of possible positions of the object whose position is to be determined. In particular, at least two sets of possible positions are thus formed.

According to the invention, an intersection of the sets of possible positions, i.e. in particular an accumulation of possible starting positions of the respective sets of possible positions in a place, position, layer or area, can be used as a position or, in particular if, in particular mathematically, no unambiguous solution is possible and/or if the intersection comprises several intersection points, several possible positions of the object whose position is to be determined, in particular of the first object or of the second object.

When forming the intersection points, a certain degree of fuzziness or inaccuracy can also be taken into account, so that practically intersections with a distance within a tolerance predetermined from measured values and/or probabilities are regarded as intersection points.

The sets of possible positions can also contain probabilities for the individual possible positions which can, for example, be derived from signal component energies, reflection frequencies. When determining the intersection points of the sets of possible positions, probabilities for the intersection points and thus positions can then be determined from the probabilities of the possible positions and, if applicable, neighboring possible positions.

For example, several sets of possible positions are formed for each receiver and/or transmitter based on the signal components and the signal paths determined from them and the possible starting positions that can be associated with them. For example, starting positions and sets of positions are also formed that do not correspond to the actual position of the object, in particular the first or second object. It is therefore possible that a possible starting position is determined from a signal component assuming an LOS signal, although the signal component would have to be assigned to a non-LOS signal, i.e. a signal that has been reflected. Nevertheless, a set of possible positions is also formed, for example, from the signal component under such an assumption. As a rule, it is sufficient if the signal components of at least two signal paths and ultimately at least two sets of possible positions are formed from this. By comparing these sets with one another and determining the intersection of these sets, it is usually possible to determine the position, at least the 2D position, of the object, at least approximately.

By determining the at least two signal path lengths for each receiver and/or transmitter, forming a set of possible positions from these and using these sets of possible positions, the position of the transmitter or receiver can be determined efficiently, optionally without additional receivers and/or transmitters.

Advantageously, at least one signal path reflecting the respective signal path length can be determined for each of the at least two determined signal path lengths. More preferably, all possible signal paths based on the reflective surfaces can be determined for each of the at least two determined signal path lengths. Advantageously, at least one possible starting position of the signal can be determined for each of the signal paths.

For example, for each of the at least two determined signal path lengths, a first signal path reflecting the signal runtime of the received signal that has not undergone reflection of the received signal at one of the reflective surfaces, a second signal path reflecting the signal runtime of the received signal that has undergone reflection of the received signal at one of the reflective surfaces, and a third signal path reflecting the signal runtime of the received signal that has undergone two reflections of the received signal at the reflective surfaces can be determined.

Preferably, particularly when operating at high frequencies, i.e. in particular above 1 GHz, depending on the design and in particular the available hardware and/or accuracy of the time synchronization, the radio signal will contain at least one frequency pair, i.e. at least two frequencies, each with a frequency difference between the frequencies of the pair and at least one change in the phase change between the at least two frequencies of a frequency pair, and signal components of at least two signal paths are determined. For this purpose, the phase shifts measured at the two frequencies of the pair can be subtracted from each other, in particular with signal time resolution. Signal time resolution means a resolution based on a time calculation, e.g. from the start of the radio signal, e.g. at the receiver. If, for example, the frequencies are transmitted one after the other in the signal, the reception times must be corrected with the shifted transmission times. If, for example, the channel-related or transmission-related phase shift (Phi) is measured on both frequencies as a function of the signal time (ts) of the radio signal between the transmitter and receiver, for example as data set Phi(ts,f), these can be subtracted, for example as Phi(ts,f1)−Phi(ts,f2)=Phi(ts, fl−f2). Signal components can then be determined from Phi(ts,f1−f2) and any other data sets. The amplitude (A) or signal energy (E) can also be used here, for example when using use complex calculation methods. This can, for example, an average value can be taken between the amplitudes at fl and f2 with signal time resolution, for example using A(ts, fl−f2)=(A(ts,f1)+A(ts, f2))/2 or E(ts, f1−f2)=(E(ts,f1)+E(ts, f2))/2.

This method makes it possible to work at a virtual frequency given by the frequency difference, which significantly reduces the requirements for the measurements. For example, it is possible to work in the Bluetooth band with the frequency pair f2=2.40 and f1=2.48 GHZ and thus with a virtual frequency of 80 MHz. This also avoids problems caused by phase jumps in the reflection, in particular if the frequency difference is not too large, as the phase jumps then generally behave the same at the frequencies of a pair. By measuring at different frequencies whose difference is selected in the range of 50-500 MHz in particular, a particularly error-tolerant determination can be made, which can also avoid the ambiguity problem quite reliably, because a measurement is only carried out virtually at the frequency difference, so to speak. If a measurement is carried out in the 2.4 GHz band with the frequencies 2400 and 2480 MHz, for example, the difference is only 80 MHz. Then 12 ns correspond to 360° phase rotation, so that with an accuracy of the phase measurement in the range of +/−3 to 6° a fairly good resolution can be achieved and this with only low demands on the avoidance of ambiguity problems with regard to the phase position. Using different frequency differences allows a high level of accuracy to be achieved in a simple manner.

A large number of frequency pairs and frequency differences can be formed from a plurality of frequencies.

Advantageously, the radio signal includes at least one frequency pair, in particular a plurality of frequency pairs, each with a frequency difference between the frequencies of the pair and changes in the phase changes between the at least two frequencies of a frequency pair are determined and the signal components of the at least two signal paths are determined from the changes.

Advantageously, the at least one frequency may comprise a plurality of frequencies. Advantageously, the at least one frequency may comprise at least five and/or a maximum of 200 frequencies.

The at least one radio signal can contain different frequencies simultaneously and/or consecutively.

Advantageously, the frequency interval between two successive frequencies of the plurality of frequencies and/or the frequency interval between two adjacent frequencies of the plurality of frequencies can be at least 0.1 MHz and/or at most 100 MHz, in particular at most 10 MHz.

Advantageously, the frequencies, in particular a plurality of or several frequencies, can span a frequency band of at least 2 MHz and/or a maximum of 100 MHz.

Advantageously, a plurality of second objects is present and set up and, in particular, configured to receive the at least one radio signal in each case that is transmitted in particular by the at least one first object. Advantageously, a plurality of first objects is present and set up and, in particular, configured to transmit at least one radio signal in each case and the at least one receiver is set up to receive the radio signals. Advantageously, for each second object of the plurality of second objects and/or from each of the signals received at the respective second object, the signal components of at least one signal path for each of the signals received at the respective second object can be determined, in particular at least two signal paths with respect to at least one second object. In particular, the same frequency is used in each case, i.e. in particular the same frequency of the signal received at the respective second object. Advantageously, a signal path length between the respective second object and the first object and, for example, a respective set of possible positions can be determined for each of the aforementioned determined signal components. Advantageously, the intersection of the sets of possible positions based in each case on the signals received at the second objects can be used as a possible position of the first object.

Advantageously, a plurality of second objects is present and set up and, in particular, configured to transmit at least one radio signal and the first object is set up to receive said radio signal. Advantageously, for each second object of the plurality of second objects and/or from each of the signals received by the respective second object, the signal components of at least one signal path of the signal transmitted by the respective second object can be determined, in particular at least two signal paths with respect to at least one second object. In particular, the same frequency is used in each case, i.e. in particular the same frequency of the signal transmitted by the respective second object. Advantageously, a signal path length between the respective second object and the first object and, for example, a respective set of possible positions can be determined for each of the aforementioned determined signal components. Advantageously, the intersection of the sets of possible positions based in each case on the signals received from the second objects can be used as a possible position of the first object.

The object is also achieved by a system comprising at least one first object, at least one second object and at least one computing unit connected to at least one of the first and/or second objects for performing the calculations, in particular determining the signal paths, signal path lengths, sets of possible positions and/or intersections.

Advantageously, the at least one first object is set up and, in particular, configured in order to carry out the method according to the invention. In particular, the at least one first object can be a transmitter or even a transceiver.

Advantageously, the at least one second object is set up and, in particular, configured in order to carry out the method according to the invention. In particular, the at least one second object can be a transmitter or even a transceiver.

Advantageously, the computing unit can be set up to carry out the method according to the invention. Advantageously, the position of either the at least one first object or the at least one second object, in particular in relation to the above-mentioned reference system, is known to the computing unit. Advantageously, the position of the at least one reflective surface, in particular with respect to the above-mentioned reference system, is known to the computing unit.

Further advantageous embodiments can be derived, for example, from the following description of an embodiment based on the attached schematic figures.

### BRIEF DESCRIPTION OF THE DRAWINGS

FIG. 1 shows a schematic view of a space with illustration of a number of signal paths.

The embodiments in the figures are shown as sketches so that individual features of the invention are particularly easy and clear to see. The proportions therefore do not have to be shown realistically. In the figures, identical elements have identical reference numbers.

### DETAILED DESCRIPTION

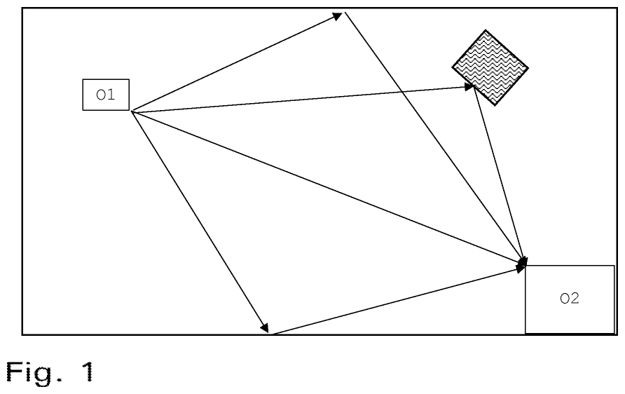

FIG. 1 shows a space enclosed by four walls with a transmitter 01, a receiver 02 and a column. A few selected different signal paths of different signal path lengths from transmitter to receiver are illustrated.

What is claimed:

1. A method for determining a position of a first object arranged in a space, wherein the method comprises:
transmitting at least one radio signal from the first object;
arranging at least one second object in the space;
setting up a receiver to receive the at least one radio signal transmitted by the first object;
wherein said at least one radio signal contains at least one frequency and at any time has a maximum bandwidth of 50 MHz, with a position of at least one reflective surface reflecting the at least one radio signal and thus generating an extended signal path;
wherein a position of the receiver is known in relation to the space;
determining signal components from a received radio signal;
wherein the at least one radio signal contains at least one frequency pair with a respective frequency difference between frequencies of the pair;
wherein changes in phase changes between the frequencies of the pair are determined from the received radio signal using phase measurements on the at least one radio signal, and the signal components of at least two signal paths with different signal path lengths of the received radio signal being determined from the changes; and
determining at least one possible starting position of the at least one radio signal as one or more possible position(s) of the first object, wherein the at least one possible starting position is determined in such a way that a hypothetical radio signal transmitted from the at least one possible starting position propagates to the at least one second object via signal paths whose signal path lengths correlate with those of the at least two determined signal paths.

2. The method according to claim 1, wherein the at least one radio signal has, at any time, a maximum bandwidth of 25 MHz.

3. The method according to claim 1, further comprising determining a signal path length between the receiver and the first object for each determined signal component, and wherein at least one possible starting position of the radio signal is determined for each of at least two determined signal path lengths, and wherein the at least one possible starting position of the signal path length of the at least two determined signal path lengths each form a set of possible positions with an intersection of the sets of possible positions being used as the one or more possible position(s) of the first object.

4. The method according to claim 1, wherein, for a plurality of candidates for the at least one possible starting positions, determining whether signal path lengths of signal paths of a propagation of an emitted hypothetical radio signal from a respective candidate to the at least one second object correlate with the signal paths of the at least two determined signal paths.

5. The method according to claim 1, wherein a respective candidate is assumed to be a possible position of the one or more possible position(s) of the first object if the correlation exceeds a predetermined correlation.

6. The method according to claim 1, wherein candidates for possible starting positions are points in a grid or in which points that lie in a circle around the receiver, a sphere around the receiver or in a circular ring or a spherical ring around the receiver are used as for the at least one possible starting position.

7. The method according to claim 6, wherein an outer radius or a radius of the circle, the sphere, the circular ring, or the spherical ring around the receiver is laying in the ring with a shortest of the at least two determined signal paths.

8. The method according to claim 1, further comprising determining at least one signal path reflecting a respective signal path length for each of the at least two determined signal path lengths, and determining at least one possible starting position of the at least one radio signal for each of the at least two determined signal paths.

9. The method according to claim 8, wherein surfaces are determined for all signal path lengths possible on the basis of the reflection.

10. The method according to claim 1, wherein the at least one frequency comprises a plurality of frequencies, a frequency interval between two consecutive or adjacent frequencies of the plurality of frequencies is at least 0.1 MHz or at most 10 MHz, or wherein the plurality of frequencies span a frequency band of at least 2 MHz or a maximum of 100 MHz.

11. The method according to claim 1, wherein the at least one frequency comprises a plurality of frequencies and the plurality of frequencies span a frequency band of at least 2 MHz or a maximum of 100 MHz or span between 2 MHz and 100 MHz.

12. The method according to claim 1, further comprising reducing a calculation work by taking into account at least one boundary condition derived from the at least one radio signal, by considering only a subset of all possible candidates for the at least one possible starting position, the selection of which is determined on a basis of a comparison of a distance of the at least one possible starting position to the at least one second object and a shortest signal path length of the signal components or by limiting a number of reflections considered on the basis of a number of different signal path lengths of the at least two signal path lengths to the at least one second object.

13. The method according to claim 1, wherein the at least one second object comprises a plurality of second objects which are set up to each receive the at least one radio signal transmitted by the first object, with the signal components of at least one signal path of the at least one received radio signal being determined from each of radio signal of the at least one radio signal received at a respective receiver using in each case at least one phase measurement on the at least one radio signal, said signal components of at least two signal paths with different signal path lengths of the received radio signal being determined at least from the at least one radio signal received at one of the receivers using at least one phase measurement on the at least one radio signal, and at least one possible starting position of the at least one radio signal being determined as the one or more possible position(s) of the first object, the at least one possible starting position being determined in such a way that a hypothetical radio signal transmitted from the at least one possible starting position propagates to the plurality of second objects in each case via signal paths whose signal path lengths correlate with those of the respective determined signal paths.

14. The method according to claim 13, wherein the signal components of the at least two signal paths of the respective received radio signal are determined from each of the radio signal received at the respective receiver and the signal path length between the respective receiver and the first object is determined for each of the determined signal components, at least one possible starting position of the at least one radio signal being determined for each of the at least two signal path lengths determined for each receiver, the possible starting positions of the signal path length of each receiver in each case forming a set of possible positions, with an intersection of the sets of possible positions of the receivers being used as the one or more possible position(s) of the first object.

15. The method according to claim 1, wherein the at least one second object comprises a plurality of second objects which are set up to each receive the at least one radio signal transmitted by the first object, wherein for a plurality of possible starting positions it is possible to determine whether signal path lengths of signal paths of the propagation of a transmitted hypothetical radio signal from the respective starting position to the plurality of second objects with those of the respective at least two signal paths and, in the case of a correlation exceeding a predetermined correlation, the respective possible starting position is assumed to be a possible position of the one or more possible position(s) of the first object.

16. The method according to claim 1, wherein a probability is determined for each of the one or more possible position(s).
